(19) United States
(12) Patent Application Publication
(10) Pub. No.: US 2005/0075127 A1
(43) Pub. Date: Apr. 7, 2005

(54) Mobile phone

(76) Inventors: Mark Edward Simek, San Diego, CA (US); Robert B. Ganton, San Diego, CA (US); Sidney Sitachitt, Carlsbad, CA (US); Gad Shaanan, La Jolla, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 10/665,691

(22) Filed: Sep. 19, 2003

(51) Int. Cl. H04M 1/00

(52) U.S. Cl. 455/550.1

(57) ABSTRACT

A mobile phone includes a mobile phone housing including a front face, a left side face, a right side face, and a width W between the left side face and the right side face; a speaker disposed in and outwardly directed from the front face of the housing; a microphone disposed in and outwardly directed from the front face of the housing and spaced a distance D from the speaker when the mobile phone is ready for taking or placing a call; a display disposed in and outwardly directed from the front face of the housing; a phone number keypad including a plurality of telephone number input keys to dial a phone number to place a call, the telephone number input keys located in a position other than centered on the front face with respect to the left side face and the right side face; and the ratio of the distance D to the width W being greater than 4.

### FIELD OF THE INVENTION

The present invention is in the field of wireless mobile phones.

### BACKGROUND OF THE INVENTION

There has been a general trend in the mobile phone industry to decrease the size and weight of wireless mobile phones. Although this makes the mobile phones more convenient to carry and less obtrusive, this decrease in size makes it difficult to fit essential mobile phone features (e.g., keypad, display, speaker(s), microphone) on the mobile phone.

### SUMMARY OF THE INVENTION

Accordingly, an aspect of the invention involves a wireless mobile phone that includes one or more essential mobile phone features located on a face of the mobile phone other than the front face of the mobile phone, where these features have been traditionally located.

In another aspect of the invention the keypad of the mobile phone is linear and is located along at least one of the lateral side faces of the mobile phone, allowing the mobile phone to have a smaller, thinner, sleeker profile and making the mobile phone easier to carry.

Further objects and advantages will be apparent to those skilled in the art after a review of the drawings and the detailed description of the preferred embodiments set forth below.

### BRIEF DESCRIPTION OF THE DRAWINGS

FIG. 1A is a front elevational view of a generic mobile phone constructed in accordance with an embodiment of the invention.

FIG. 1B is a side elevational view of the generic mobile phone illustrated in FIG. 1 taken along lines 1B-1B in FIG. 1A.

FIG. 2A is a front elevational view of a mobile phone constructed in accordance with another embodiment of the invention.

FIG. 2B is a side elevational view of the mobile phone illustrated in FIG. 2A taken along lines 2B-2B of FIG. 2A.

FIG. 2C is a cross-sectional outline view of the mobile phone illustrated in FIG. 2A taken along lines 2C-2C of FIG. 2A.

FIG. 3A is a front elevational view of a mobile phone constructed in accordance with an additional embodiment of the invention.

FIG. 3B is a side elevational view of the mobile phone illustrated in FIG. 3A taken along lines 3B-3B of FIG. 3A.

FIG. 3C is a cross-sectional outline view of the mobile phone illustrated in FIG. 3A taken along lines 3C-3C of FIG. 3A.

FIG. 4A is a front elevational view of a mobile phone constructed in accordance with a further embodiment of the invention.

FIG. 4B is a side elevational view of the mobile phone illustrated in FIG. 4A taken along lines 4B-4B of FIG. 4A.

FIG. 4C is a cross-sectional outline view of the mobile phone illustrated in FIG. 4A taken along lines 4C-4C of FIG. 4A.

FIG. 4D is a rear elevational view of the mobile phone illustrated in FIG. 4A taken along lines 4D-4D of FIG. 4A.

FIG. 5A is a front elevational view of a mobile phone constructed in accordance with a still further embodiment of the invention.

FIG. 5B is a side elevational view of the mobile phone illustrated in FIG. 5A taken along lines 5B-5B of FIG. 5A.

FIG. 5C is a cross-sectional outline view of the mobile phone illustrated in FIG. 5A taken along lines 5C-5C of FIG. 5A.

FIG. 5D is a rear elevational view of the mobile phone illustrated in FIG. 5A taken along lines 5D-5D of FIG. 5A.

### DETAILED DESCRIPTION OF PREFERRED EMBODIMENTS

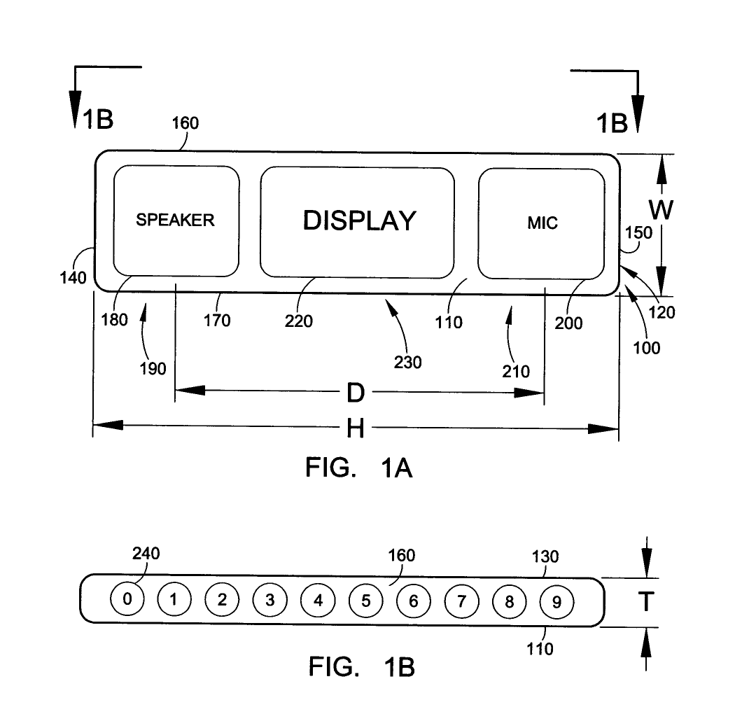

With reference to FIGS. 1A-1B, an embodiment of a generic mobile phone 100 including one or more essential mobile phone features located on a face of the mobile phone 100 other than a front face 110 of the mobile phone 100 will now be described.

The mobile phone 100 includes a housing 120 with the following six sides, faces, or edges (hereinafter “faces”): front face 110, rear face 130, top face 140, bottom face 150, right side face 160, and left side face 170.

Although not shown, a retractable antenna may be outwardly extendable from the housing 120. A speaker 180 is disposed in and outwardly directed from the housing 120 in a top portion 190 of the of the housing 120. A microphone 200 is disposed in and is outwardly directed from a bottom portion 210 the housing 120. A display 220 such as, but not limited to, a Liquid Crystal Display (LCD) is disposed in and outwardly directed from the housing 120 in a central portion 230 of the housing 120.

As shown in FIG. 1B, a linear phone number keypad 230 is disposed in and is laterally outwardly directed from the right side face 160. The linear phone number keypad 230 includes linearly aligned telephone number input keys 240 corresponding to the numbers 0, 1, 2, 3, 4, 5, 6, 7, 8, 9 for inputting these numbers into the mobile phone 100 for placing a call. The telephone number input keys 240 may be operatively connected to or part of a flexible electrical circuit or other electrical circuit for inputting the corresponding numbers or other data represented by the keys 240 into the mobile phone 100. Although the telephone number input keys 240 are shown as being circular, the telephone number input keys 240 may have one or more configurations other than being circular. The telephone number input keys 240 may be dome-shaped or have an alternative configuration or contour. Although ten telephone number input keys 240 are shown, additional input keys in addition to the telephone number input keys 240 may be provided. Although the telephone number input keys 240 are described as being used to input corresponding numbers into the mobile phone 100 for placing a call, one or more of these input keys 240 may be used to perform one or more functions in addition to inputting numbers into the mobile phone 100. Although the telephone number input keys 240 are described and shown as being entirely disposed in the right side face 160, the telephone number input keys 240 may be disposed in one or more faces other than the front face 110 or may be disposed in one or more faces in addition to the front face 110.

The mobile 100 phone has a width W, a thickness T, a height H, and a speaker-to-microphone distance D. The speaker-to-microphone distance D is the distance between the speaker 180 and the microphone 200 when the mobile phone 100 is in the active, ready-to-use, or open position as shown in FIGS. 1A and 1B. For some mobile phones (e.g. non-flip phones), this distance D is constant. For other mobile phones (e.g., flip phones) this distance D varies, depending on whether the mobile phone is in the open position or the closed position. Locating the telephone number input keys 240 on one or more faces other than the front face 110 or in addition to the front face 110 allows the mobile phone 100 to have a much smaller width W than mobile phones in the past, allowing the mobile phone 100 to have a smaller, thinner, sleeker profile and making the mobile phone 100 easier to carry.

In a preferred embodiment, the ratio of the width to thickness (W/T) is less than 4; in a more preferred embodiment, the ratio of the width to thickness is less than 3, and in most preferred embodiment, the ratio of the width to thickness is less than 2.

In a preferred embodiment, the ratio of the speaker-to-microphone distance to width (D/W) is greater than 4.

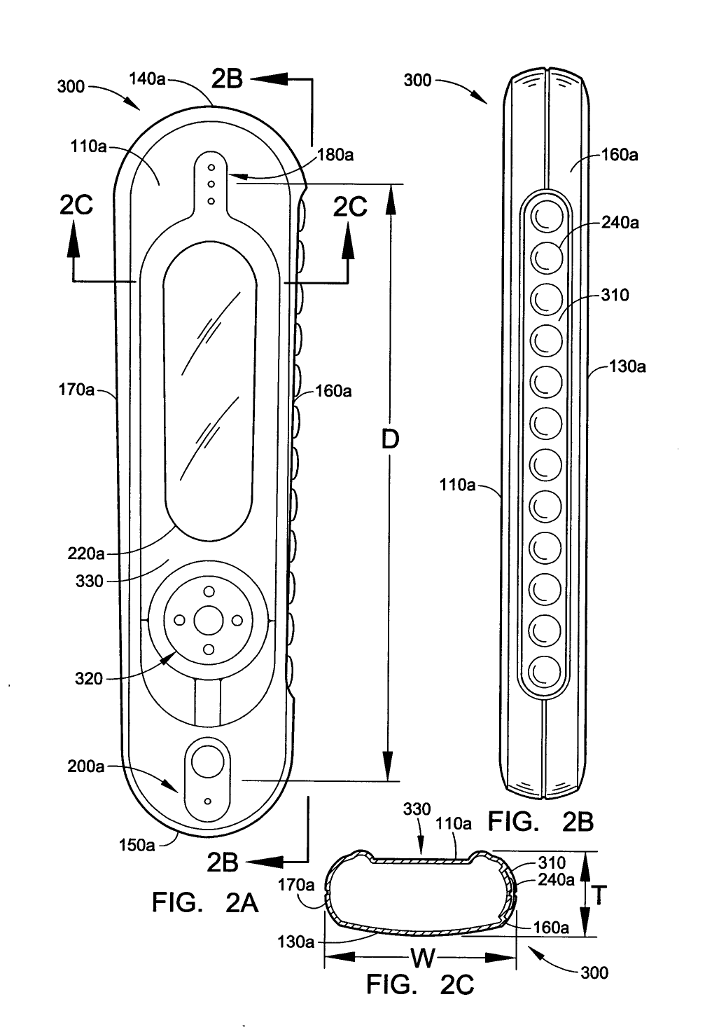

With reference to FIGS. 2A-2C, another embodiment of a mobile phone 300 including one or more essential mobile phone features located on a face of the mobile phone 100 other than a front face 110a of the mobile phone 300 will now be described. In the embodiment of FIGS. 2A-2C and additional embodiments describe below, like elements to those shown and described with respect to FIGS. 1A-1B will be identified with similar reference numbers, but with a different letter suffix (e.g., 110a, 110b, 110c, etc.).

Similar to the mobile phone 100 described above with respect to FIGS. 1A-1B, the mobile phone 300 includes the telephone number input keys 240a in a right side face 160a of the mobile phone 300. The telephone number input keys 240a are linearly aligned within an elongated recess 310 on the right side face 160a. An elliptical display 220a and a multi-directional thumb pad 320 are centered with respect to the side faces 160a, 170a within a recess 330 on the front face 110a.

The mobile phone 300 has a ratio of width-to-thickness (W/T) of 1.91 and a ratio of the speaker-to-microphone distance to width (D/W) greater than 4.

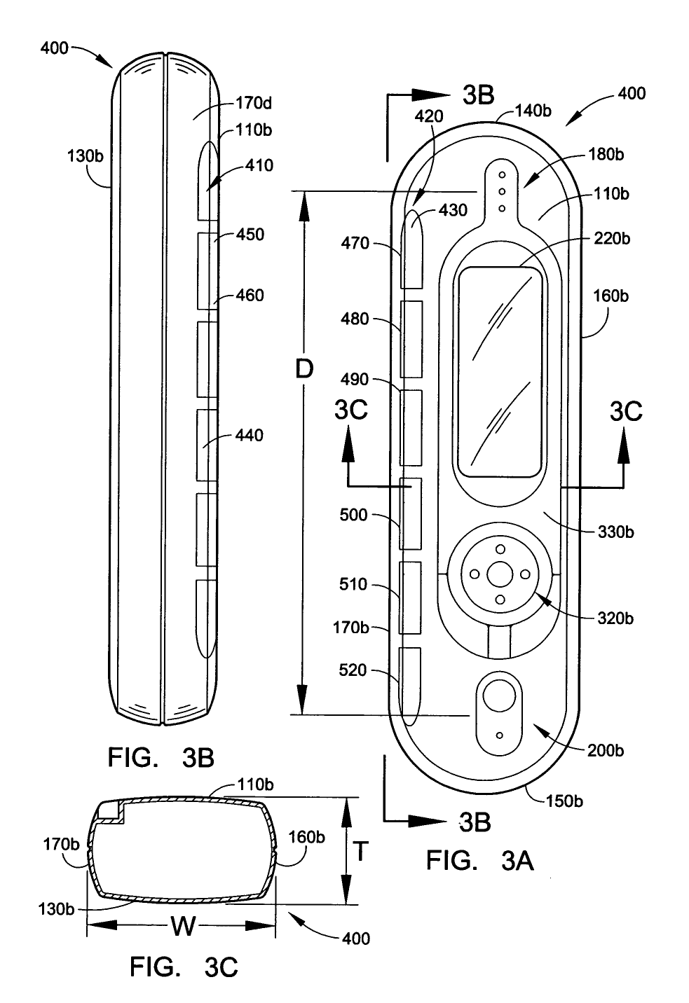

With reference to FIGS. 3A-3C, another embodiment of a mobile phone 400 including one or more essential mobile phone features located on a face of the mobile phone 400 in addition to the front face 110b of the mobile phone 400 will now be described.

The mobile phone 400 includes a speaker 180b, display 220b, multi-directional thumb pad 320b, recess 330b, and microphone 200b configuration similar to that shown and described above with respect to FIGS. 2A-2C, except the entire configuration is offset to the right with respect to the side faces 160b, 170b (instead of centered) and the display 220b is generally rectangular (instead of elliptical).

Offsetting the speaker 180b, display 220b, multi-directional thumb pad 320b, recess 330b, and microphone 200b configuration to the right allows telephone number input keys 410 to be disposed along a left edge 420 of the mobile phone 400. Because the input keys 410 are disposed along the left edge 420, the input keys 410 are located on the left side face 170b in addition to the front face 110b. Each input key 410 includes a top surface 430 generally parallel with the front face 110b and a side surface 440 generally parallel with the left side face 170b. Each input key 410 may include a top portion 450 and a bottom portion 460. The top portion 450 of the input key 410 may represent an input key of a standard mobile phone and the bottom portion 460 may represent a subsequent input key of a standard mobile phone. For example, the top portion 450 of a first input key 470 may represent 1, the bottom portion 460 of the first input key 470 may represent 2 and a, b, c; the top portion 450 of a second input key 480 may represent 3 and d, e, f and the bottom portion 460 of the second input key 480 may represent 4 and g, h, i; the top portion 450 of a third input key 490 may represent 5 and j, k, I and the bottom portion 460 of the third input key 490 may represent 6 and m, n, o; the top portion 450 of a fourth input key 500 may represent 7 and p, q, r, s and the bottom portion 460 of the fourth input key 500 may represent 8 and t, u, v; the top portion 450 of a fifth input key 510 may represent 9 and w, x, y, z and the bottom portion 460 of the fifth input key 510 may represent 0; and the top portion 450 of a sixth input key 520 may represent * and the bottom portion 460 of the sixth input key 520 may represent #. A pivotal connection on the underside of each input key 410, near its longitudinal center, allows each input key 410 to function as the equivalent of two separate input keys. Pressing down on the top portion 450 causes the character representative of the top portion 450 to be input into the mobile phone and pressing down on the bottom portion 460 causes the character representative of the bottom portion 460 to be input into the mobile phone 400.

The mobile phone 400 has a ratio of width-to-thickness (W/T) of 1.67 and a ratio of the speaker-to-microphone distance to width (D/W) greater than 4.

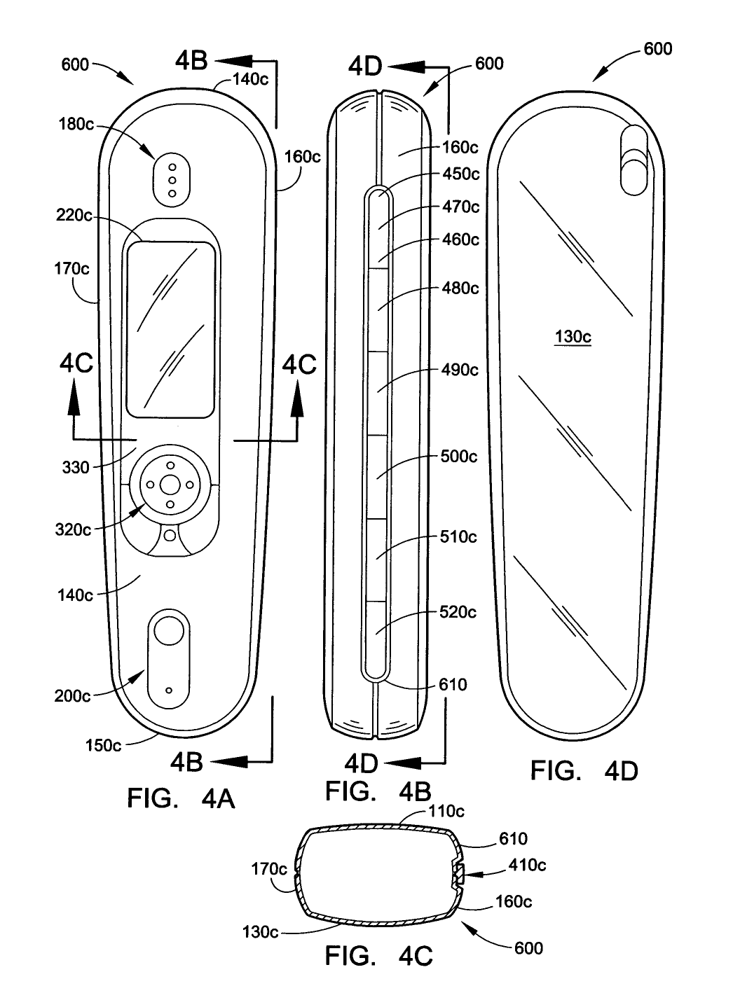

With reference to FIGS. 4A-4D, a further embodiment of a mobile phone 600 including one or more essential mobile phone features located on a face of the mobile phone 600 other than the front face 110c will now be described.

The mobile phone 600 includes a speaker 180c, display 220c, multi-directional thumb pad 320c, recess 330c, and microphone 200c configuration similar to that shown and described above with respect to FIGS. 3A-3C, except the entire configuration is offset to the left with respect to the side faces 160c, 170c (instead of offset to the right) and the outer design of the speaker 180c and microphone 200c areas are slightly different.

Offsetting the speaker 180c, display 220c, multi-directional thumb pad 320c, recess 330c, and microphone 200c configuration to the left allows telephone number input keys 410c to be disposed along the right side face 160c of the mobile phone 600. The input keys 410c are similar to the input keys 410 described above with respect to FIGS. 3A-3C, except they have a slightly different configuration and are disposed within a recess 610 on the right side face 160c.

The mobile phone 600 has a ratio of width-to-thickness (W/T) of 1.62 and a ratio of the speaker-to-microphone distance to width (D/W) greater than 4.

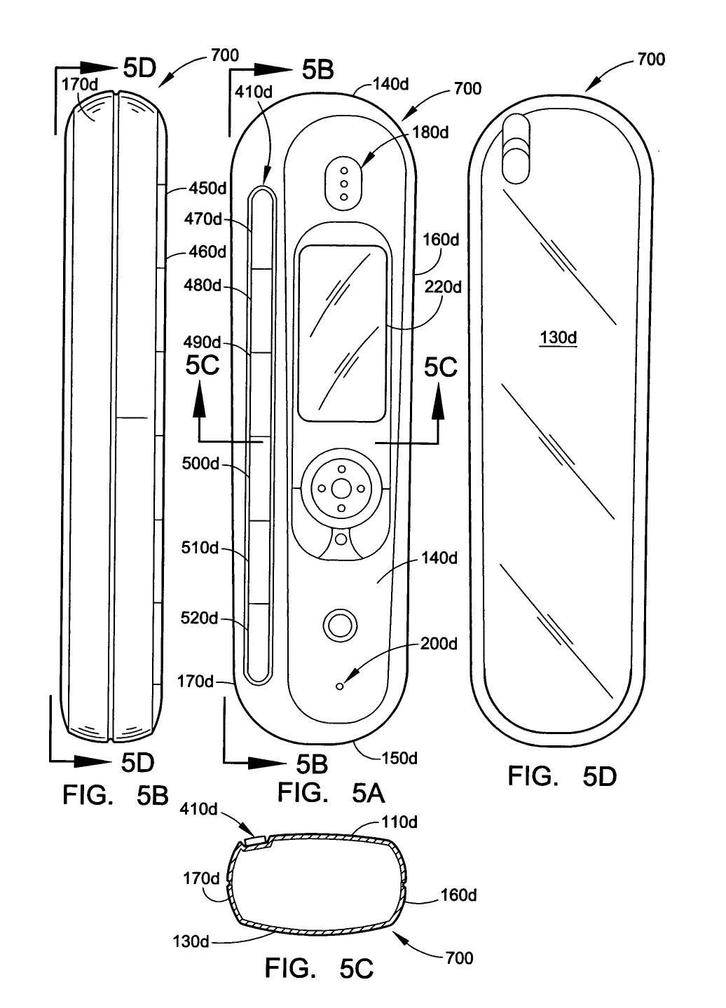

With reference to FIGS. 5A-5D, a still further embodiment of a mobile phone 700 including a plurality of telephone number input keys 410d located on the front face 110d of the mobile phone 700 will now be described.

The mobile phone 700 includes a speaker 180d, display 220d, multi-directional thumb pad 320d, recess 330d, and microphone 200d configuration similar to that shown and described above with respect to FIGS. 3A-3C, except the outer design of the speaker 180d and microphone 200d areas are slightly different.

Similar to the embodiment of FIGS. 3A-3C, offsetting the speaker 180d, display 220d, multi-directional thumb pad 320d, recess 330d, and microphone 200d configuration to the right allows the linearly aligned telephone number input keys 410d to be disposed on the front face 140d, adjacent the left side face 170d. The input keys 410d are similar to the input keys 410, 410c described above.

The mobile phone 700 has a ratio of width-to-thickness (W/T) of 1.67 and a ratio of the speaker-to-microphone distance to width (D/W) greater than 4.

From the foregoing discussion, it is readily apparent that locating one or more essential mobile phone features, in particular, locating a plurality of linearly aligned telephone number input keys, on a face of the mobile phone other than and/or in addition to the front face of the mobile phone allows the mobile phone 100 to have a much smaller width W than mobile phones in the past, allowing the mobile phone 100 to have a smaller, thinner, sleeker profile and making the mobile phone easier to carry.

It will be readily apparent to those skilled in the art that still further changes and modifications in the actual concepts described herein can readily be made without departing from the spirit and scope of the invention as defined by the following claims.

1. A mobile phone, comprising:
a mobile phone housing including a front face, a left side face, a right side face, and a width W between the left side face and the right side face;
a speaker disposed in and outwardly directed from the front face of the housing;
a microphone disposed in and outwardly directed from the front face of the housing and spaced a distance D from the speaker when the mobile phone is ready for taking or placing a call;
a display disposed in and outwardly directed from the front face of the housing;
a phone number keypad including a plurality of telephone number input keys to dial a phone number to place a call, the telephone number input keys located in a position other than centered on the front face with respect to the left side face and the right side face;
wherein the ratio of the distance D to the width W is greater than 4.

2. The mobile phone of claim 1, wherein the telephone number input keys are linearly aligned.

3. The mobile phone of claim 1, wherein the telephone number input keys are located on one of the left side face and the right side face.

4. The mobile phone of claim 1, further including a left edge where the left side face and the front face intersect and a right edge where the right side face and the front face intersect, and the telephone number input keys are located on one of the left edge and the right edge.

5. The mobile phone of claim 1, further including a left edge where the left side face and the front face intersect and a right edge where the right side face and the front face intersect, and the telephone number input keys are located on the front face adjacent one of the left edge and the right edge.

6. The mobile phone of claim 1, wherein the mobile phone includes a thickness T, and the ratio of the width W to the thickness T is less than 2.

7. The mobile phone of claim 1, wherein the mobile phone includes ten respective telephone number input keys for inputting the numbers 0-9.

8. The mobile phone of claim 1, wherein the mobile phone includes five telephone number input keys for inputting the numbers 0-9, each telephone number input key to input two different numbers.

9. A mobile phone, comprising:
a mobile phone housing including a front face, a left side face, a right side face, and a width W between the left side face and the right side face;
a speaker, a microphone, a display, a phone number keypad carried by the housing, the microphone spaced a distance D from the speaker when the mobile phone is ready for taking or placing a call;
the speaker, the microphone, the display, and the phone number keypad positioned so that the ratio of the distance D to the width W is greater than 4.

10. The mobile phone of claim 9, wherein the phone number keypad includes a plurality of telephone number input keys that are linearly aligned.

11. The mobile phone of claim 10, wherein the telephone number input keys are located on one of the left side face and the right side face.

12. The mobile phone of claim 10, further including a left edge where the left side face and the front face intersect and a right edge where the right side face and the front face intersect, and the telephone number input keys are located on one of the left edge and the right edge.

13. The mobile phone of claim 10, further including a left edge where the left side face and the front face intersect and a right edge where the right side face and the front face intersect, and the telephone number input keys are located on the front face adjacent one of the left edge and the right edge.

14. The mobile phone of claim 9, wherein the mobile phone includes a thickness T, and the ratio of the width W to the thickness T is less than 2.

15. The mobile phone of claim 10, wherein the mobile phone includes ten respective telephone number input keys for inputting the numbers 0-9.

16. The mobile phone of claim 10, wherein the mobile phone includes five telephone number input keys for inputting the numbers 0-9, each telephone number input key to input two different numbers.

17. A mobile phone, comprising:
a mobile phone housing including a front face, a left side face, and a right side face;
a speaker disposed in and outwardly directed from the front face of the housing;
a microphone disposed in and outwardly directed from the front face of the housing;
a display disposed in and outwardly directed from the front face of the housing;
a phone number keypad including a plurality of linearly aligned telephone number input keys to dial a phone number to place a call, the telephone number input keys located in a position other than centered on the front face with respect to the left side face and the right side face.

18. The mobile phone of claim 17, wherein the telephone number input keys are located on one of the left side face and the right side face.

19. The mobile phone of claim 17, further including a left edge where the left side face and the front face intersect and a right edge where the right side face and the front face intersect, and the telephone number input keys are located on one of the left edge and the right edge.

20. The mobile phone of claim 17, further including a left edge where the left side face and the front face intersect and a right edge where the right side face and the front face intersect, and the telephone number input keys are located on the front face adjacent one of the left edge and the right edge.
